(19) United States
(12) Patent Application Publication
(10) Pub. No.: US 2014/0164039 A1
(43) Pub. Date: Jun. 12, 2014

(54) SYSTEM AND METHOD FOR INSPECTION OF STRUCTURES

(71) Applicant: GENERAL ELECTRIC COMPANY, Schenectady, NY (US)

(72) Inventors: AARON RICHARD MITTI, ATLANTA, GA (US); CHRISTIAN ZAMBRANO, GUAYAQUIL (EC); LANCE DEREK JACOBS, JACKSONVILLE, FL (US); MARTIN PAGET, SAINT JOHNS, FL (US)

(73) Assignee: GENERAL ELECTRIC COMPANY, Schenectady, NY (US)

(21) Appl. No.: 14/075,064

(22) Filed: Nov. 8, 2013

Related U.S. Application Data
(60) Provisional application No. 61/735,368, filed on Dec. 10, 2012.

(51) Int. Cl. G06Q 10/06

(52) U.S. Cl. CPC G06Q 10/06311
USPC 705/7.14; 705/7.13

(57) ABSTRACT

Systems and methods of the invention relate to identifying a structure and a corresponding inspection for a portion of the structure and managing an appointment to perform the inspection with one or more inspectors. An evaluate component can analyze a set of inspection rules (e.g., user-defined, regulation-defined, defined by a type of structure, among others) for one or more structures, wherein a manager component can select one or more inspectors to perform the inspection.

### CROSS-REFERENCE TO RELATED APPLICATIONS

This application claims the benefit of U.S. Provisional Application Ser. No. 61/735,368, filed Dec. 10, 2012, and entitled “SYSTEM AND METHOD FOR INSPECTION OF STRUCTURES.” The entirety of the aforementioned application is incorporated herein by reference.

### BACKGROUND

1. Technical Field

Embodiments of the subject matter disclosed herein relate to a structure inspection system and management thereof.

2. Discussion of Art

Structures such as bridges and cranes include numerous parts and elements, which may be associated with defined inspections that are required to protect the safety of people in relation to the use of structures. The integrity of each part of a structure is often verified with an inspection process at a particular frequency and/or after an engineer-defined duration of time. Inspection of these particular components may improve or extend the structural integrity, safety, and reliability through the use of replacement components or maintenance. Further, monitoring for deterioration can be included in the inspection process.

It may be desirable to have a system and method that differ from those systems and methods that are currently available.

### BRIEF DESCRIPTION

In an embodiment, a method comprises identifying a structure and an inspection to perform on at least a portion of the structure that is associated with an inspection date. The method further comprises evaluating at least one of an availability of one or more inspectors to perform the inspection on the portion of the structure no later than the inspection date or a qualification of the one or more inspectors. The one or more inspectors are scheduled to perform the inspection on the portion of the structure at a scheduled date based on at least one of the availability or the qualification. The method further comprises aggregating inspection data (e.g., aggregating a portion of the inspection data or all of the inspection data) related to a result of the inspection on the portion of the structure.

In an embodiment, a system is provided that comprises a first component configured to identify an inspection to perform on at least a portion of a structure based on at least one of a frequency for the inspection, a duration of time for the inspection, or a type of the structure. The system further comprises a second component configured to identify one or more inspectors to perform the inspection on the portion of the structure. The second component is further configured to schedule the inspection with the one or more identified inspectors.

In an embodiment, a system is provided that comprises means for identifying a structure and an inspection to perform on at least a portion of the structure by an inspection date. The system further comprises means for evaluating an availability of one or more inspectors to perform the inspection on the portion of the structure no later than the inspection date. The system further comprises means for scheduling the one or more inspectors to perform the inspection on the portion of the structure at a scheduled date and means for aggregating inspection data (e.g., all of the inspection data or a portion of the inspection data) related to a result of the inspection on the portion of the structure.

In an embodiment, a system comprises an evaluate component configured to automatically identify an inspection to perform on at least a portion of a structure that is associated with an inspection date. The system further comprises a manager component operably coupled with the evaluate component and configured to automatically schedule one or more inspectors to perform the inspection on the portion of the structure at a scheduled date based at least on an availability of the one or more inspectors and a qualification of the one or more inspectors. The scheduled date is no later than the inspection date. The manager component is further configured to receive inspection data related to a result of the inspection on the portion of the structure.

### BRIEF DESCRIPTION OF THE DRAWINGS

Reference is made to the accompanying drawings in which particular embodiments and further benefits of the invention are illustrated as described in more detail in the description below, in which:

FIG. 1 is an illustration of an embodiment of a system for scheduling an inspection for a structure based on an inspection requirement;

FIG. 2 is an illustration of an embodiment of a system for identifying an inspection for a structure and selecting one or more inspectors to perform the inspection;

FIG. 3 is an illustration of an embodiment of a system for prioritizing one or more inspections based on an amount of time until an inspection target date;

FIG. 4 is an illustration of an embodiment of a system for querying inspection data to provide results related to one or more structures; and

FIG. 5 illustrates a flow chart of an embodiment of a method for scheduling an appointment for an inspection on a structure and maintaining inspection data related to a result of the inspection.

### DETAILED DESCRIPTION

Embodiments of the invention relate to methods and systems for identifying a structure and a corresponding inspection for the structure (or portion thereof) and managing an appointment to perform the inspection with one or more inspectors. An evaluate component can analyze a set of inspection rules (e.g., user-defined, regulation-defined, defined by a type of structure, among others) for one or more structures, wherein a manager component can select one or more inspectors to perform the inspection. In an embodiment, the scheduling of the one or more inspectors can be prioritized based on urgency (e.g., amount of time until a due date to perform the inspection) and/or a cost of the inspection (e.g., travel time and distance to the structure, availability of the structure, lowest mileage route to structure, highest fuel efficiency route to structure, quickest route to structure based on traffic conditions, cost of inspection, cost of downtime to the structure, among others). In another embodiment, the manager component maintains inspection data related to a result of the inspection (e.g., a previously performed inspection, an upcoming inspection, among others).

With reference to the drawings, like reference numerals designate identical or corresponding parts throughout the several views. However, the inclusion of like elements in different views does not mean a given embodiment necessarily includes such elements or that all embodiments of the invention include such elements.

The term “component” as used herein can be defined as a portion of hardware, a portion of software, or a combination thereof. Software refers to electronically readable and/or executable instructions, stored in a non-transitory electronically-readable medium, that cause hardware to perform designated functions/actions and/or behave in a designated manner. Hardware refers to an electronic device or devices comprising circuits/circuitry (e.g., analog circuitry, microprocessors or other processing element(s) or other digital circuitry, and/or the like), possibly including a non-transitory electronically-readable medium for the storage of software, that is configured, by way of the software and/or an arrangement of the circuits/circuitry, to perform one or more designated functions/actions and/or behave in a designated manner. The term “structure” as used herein can be defined as a man-made machine or other assemblage of one or more parts such as, for example, a portable crane (or other large construction equipment) or a fixed installation (a bridge, building, roadway, permanently or semi-permanently installed crane, or other infrastructure that is fixed in a single location), among others. The structure can be inspected in order to ensure integrity of the one or more parts that comprise the structure. The term “inspection” as used herein can be defined as an organized examination, forms of tests, and/or a formal evaluation of a structure or a portion of the structure in which the inspection can relate to, for instance, an initial inspection, a routine inspection, an in-depth inspection, a special inspection, pre-inspection, structure setup, electrical hazard inspection, load capacity inspection, bridge inspection, crane inspection, mobile crane inspection, strain-gage tests, and/or material sample tests, among others. The term “individuals aggregated in an organizational structure” as used herein can be defined as one or more persons being a member in at least one of a union, a committee, a board, an elected group, an appointed group of individuals, a group, and the like.

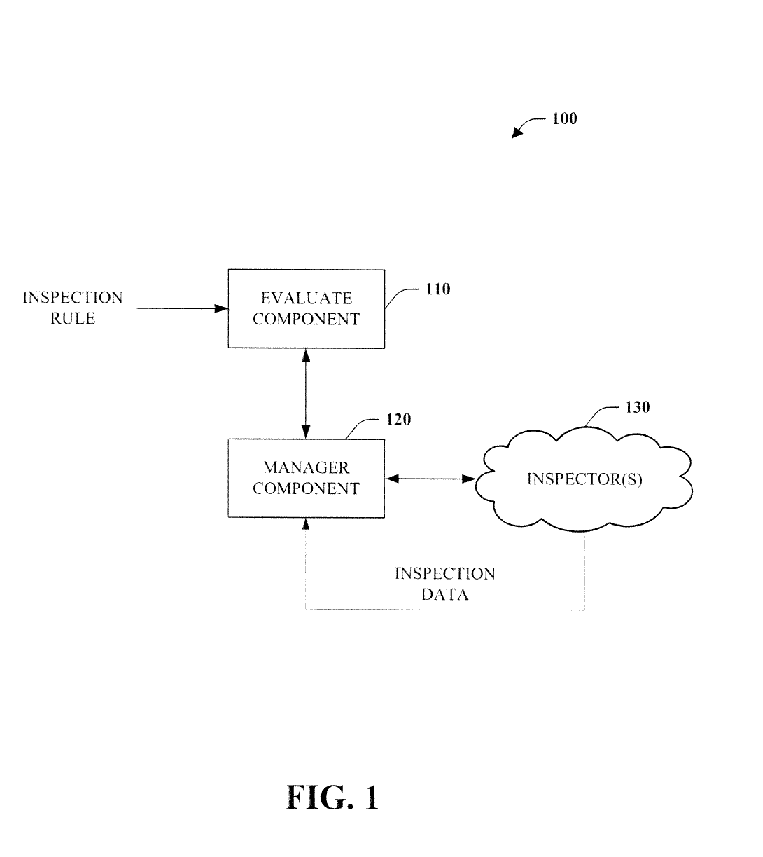

FIG. 1 is an illustration of a system 100 for scheduling an inspection for a structure based on an inspection requirement. The system includes an evaluate component 110 that is configured to aggregate and/or receive at least one inspection rule corresponding to one or more structures. The at least one inspection rule defines one or more of a period of inspection (e.g., a duration of time, a frequency of time, a period of time, seasonal requirements among others), a type of inspection (e.g., pre-inspection, in-depth inspection, among others), the inspection requirements (e.g., detailed tasks required to be performed and/or evidence that is required to be collected), a structure to on which the inspection is to be performed, and/or a type of inspection (e.g., government inspection, regulatory body inspection, state required inspection, self-imposed inspection, among others).

The system includes a manager component 120 that is configured to manage scheduling, selecting, and/or assigning of one or more inspections for one or more structures based at least in part upon the inspection rule(s). The manager component can identify one or more inspectors 130 that can perform the inspection based on criteria defined within the inspection rule(s) (e.g., inspector qualifications, due date of inspection, type of inspection, location of inspection, among others). In an embodiment, the manager component can analyze data related to the inspectors such as, but not limited to, inspector availability, inspector qualifications, type of inspector, cost of inspector, or location of inspector, among others. With regard to scheduling, selecting, and/or assigning, these may be referred to collectively as scheduling but may focus on various aspects of the activities.

In an embodiment, the system can be configured to optimize arrangement of scheduled inspections by evaluating factors such as travel distance/time, schedule of tests, availability of inspectors, availability of resources, capability of inspectors to perform the inspection, and/or availability of the structure to be able to be inspected (e.g., tracking time of an inspection performed, use of tracked inspection time from previous inspections to assist in estimating duration of time a structure is being inspected, among others).

After an inspection has been performed by the selected one or more inspectors, the manager component 120 can aggregate and/or receive inspection data related to a result of the inspection. The inspection data can include, but is not limited to including, a result of the inspection, a date of the inspection, inspector information (e.g., name, qualifications, age, company, and the like), notes related to the inspection (e.g., figures, photographs, measurements, observations, weather and structure conditions during inspection, warnings, concerns, superior conditions, and the like), location of inspection, cost of inspection, a report of the inspection, risk, potential fine avoidance for late inspections, response to an accident or audit, and/or use of structure for high-profile event, among others. The inspection date can be, for instance, received for an inspection scheduled by the system 100 or an inspection performed without being scheduled by the system 100.

For instance, an inspection rule can provide for bridge “A” (e.g., identification information for the structure) to have an in-depth inspection every 180 days. A group of inspectors can be evaluated to identify or select at least one qualified inspector to perform the in-depth inspection on bridge A on or about the 180th day since the last inspection, wherein the selection can be based on the qualifications of the inspector, cost of the inspector, availability of the inspector, experience and capabilities of the inspector, location of the inspector, previous inspections performed by the inspector, among others. Upon completion of the inspection in whole or part, inspection data can be created and/or received in which the inspection data relates to the inspection result, the inspection, the inspector, or the like. For example, an inspection report or data related to an inspection(s) can be generated based on a user request to identify an inspection status for one or more structures.

In an embodiment, the inspection rule or set of rules for each structure can be, for instance, manually set/defined, defined based on a law, defined based on a manufacturer of a portion of the structure, when and how the structure was manufactured, defined based on historical performance, defined based on previous inspection results, defined based on a review committee or agency, defined by an engineer, defined based on a safety mandate or requirement, defined based on a recall of a portion of the structure, a government entity, an agency, the Federal Railway Administration (FRA), the Occupational Safety and Health Administration (OSHA), a committee, a type of the structure, a material of the structure, a weather exposure to the structure, an exposure to a natural disaster (e.g., high winds, tornado, hurricane, earthquake, flood, among others), a location of the structure, or the like.

For instance, an inspection can be set at once every three months due to a historical evaluation of similar structures or types of structures to detect or monitor a particular portion of the structure. In an example, the inspection can be set at a frequency due to a government safety regulation or law. For example, a structure or material of the structure can be untested and/or the inspection can be unscheduled. In such a case, the structure or material can be evaluated manually with a frequency (e.g., daily, weekly, monthly, etc.) to determine if an inspection should be performed or scheduled. In other words, an inspection can determine a follow-up frequency and/or type of inspection to perform on a structure or a portion of the structure.

The system can be configured to aggregate an inventory of structures, and any changes to that inventory (e.g., configuration management of the structure), that includes, for instance, details of relevant aspects of the structure (e.g., construction type, date built, documents, engineering plans, diagrams, photographs, blueprints, schematics, among others). The system can collect data related to required inspections to be conducted which can include, for instance, type of inspection, inspection requirements, scheduling logic, among others. The system can further include evaluation of qualifications for one or more individuals or organizations that perform inspections or tasks related to the inspections (e.g., PE license, state license, validity of license, among others). In an embodiment, the system can identify events (e.g., permits, documentation, equipment, and the like) required before an inspection can occur. In another embodiment, the system can maintain a record of inspection (e.g., inspection results, documentation, details, etc.), wherein the record can be video, audio, picture, images, text, or any other tangible or electronic medium.

The system can be configured to determine compliance with at least one of personnel qualification requirements, inspection schedule, inspection requirements, timely submission of data from inspection, among others. The system can further be configured to provide performance metrics (e.g., scorecards, rankings, etc.) that illustrate performance against inspection schedule and submittal schedules for an individual or individual aggregated in an organizational structure. The system can be further configured to provide performance metrics for the structure itself that illustrate performance of the structure against inspection and other criteria specified. For instance, the performance metrics can be used to predict reliability or failure and/or for ranking or comparing structures to one another. The system can be further configured to allow a user to dynamically specify inspection requirements or tasks to perform on a portion of a structure. The system can include electronic signature capabilities considered by applicable regulatory bodies, wherein the electronic signature can be used in place of an actual signature. The system can be further configured to provide the ability to find and map the structure or a portion of the structure via a mapping tool. For instance, a user can find and map a portion of a structure with a mapping tool and within a linear designation of a railroad or other transportation route.

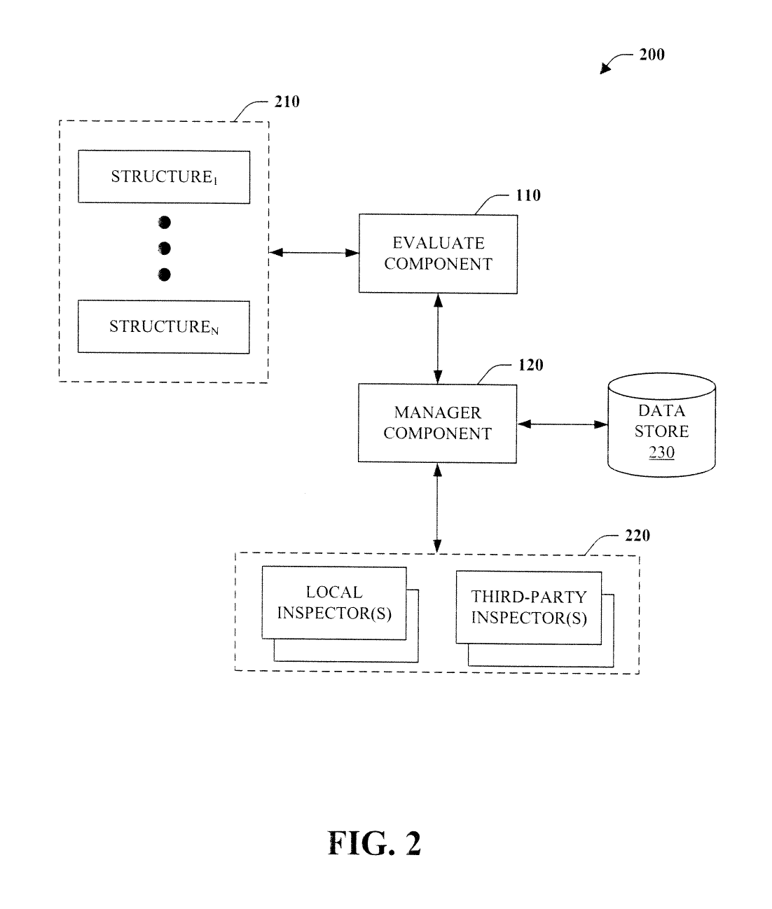

FIG. 2 is an illustration of a system 200 for identifying an inspection for a structure and selecting one or more inspectors to perform the inspection. The system includes the evaluate component 110 that analyzes information about one or more structures 210, where there can be a number of structures such as structure₁ to structure_{N}, where N is a positive integer (e.g., positive integer greater than 1). The evaluate component can be configured to indicate an inspection to perform on each structure and/or a frequency or duration of time to perform an inspection. For example, the evaluate component can be configured to evaluate factors related to the one or more structures such as, but not limited to, type of structure, historical data related to inspections, government regulation, FRA regulation, user-defined rules/regulations, location of structure, and/or material or components of the structure, among others. For instance, a type of structure can be a bridge, wherein one or more inspections can be required for such particular structure (e.g., based on previous inspections, regulations, FRA, government laws, among others).

An inspection rule can be collected and/or determined. Based on the collected and/or determined inspection rule for each structure, the evaluate component 110 can be configured to identify a structure and a corresponding inspection that is to be performed. The manager component 120 can match one or more inspectors 220 to each inspection of a structure. As referenced above, the manager component can evaluate factors such as, but not limited to, inspector qualifications, inspector availability, inspector cost, inspector specialty, previous inspections by the inspector, type of structure, location of structure, inspector location, among others. The manager component can select from one or more inspectors, wherein the inspectors can be local inspectors (e.g., employees of a company owning the structure) or third-party inspectors (e.g., non-employees of the company owning the structure). For instance, the local inspector can be an employed engineer, a staffed employee, among others. In another instance, the third-party inspector can be an independent contractor, a government employee, a state employee, a federal employee, among others. In an embodiment, the manager component can select one or more inspectors from a set of local inspectors, a set of third-party inspectors, or a combination thereof.

In an embodiment, the evaluate component and/or the manager component or other discussed components or elements (e.g., priority component, notification component, query component, among others) are configured to store information related to the systems 100, 200, 300, and/or 400 in a data store 230. The data store can include information such as, but not limited to, inspection data, scheduled inspection data, potential inspectors to hire for inspection, structure information, inspection rule, result data from inspections, among others, and/or a suitable combination thereof.

A suitable data store can be, for example, either volatile memory or nonvolatile memory, or can include both volatile and nonvolatile memory. The data store of the subject systems and methods is intended to comprise, without being limited to, these and other suitable types of memory. In addition, the data store can be a server, a database, a hard drive, a flash drive, an external hard drive, a portable hard drive, cloud-based storage, and the like. Additional hardware and software components may be needed based on the data store selection to facilitate communication and use.

In an embodiment, the system is configured to generate an electronic inspection history file that includes an identification of a structure, one or more inspections, one or more dates of the one or more inspections, and one or more results for the one or more inspections. Such electronic inspection history file can be stored in, for example, the data store. The data store, for instance, can be local, remote, cloud storage, or the like, in which various levels of access and/or security can be employed. In an embodiment, a portion of inspection data and/or a portion of the electronic inspection history file can be accessed for each user or username or role. For instance, a first user can access a first portion of data and a second user can access a second portion of the data, wherein the first portion can be greater than the second portion. In another embodiment, a subset of the data store can be made read access for a particular set of users. For instance, read access can be provided to the electronic inspection history file to the one or more inspectors or other staff having permission to access said data. For instance, a portion of the data store can be segregated and isolated for use by one or more inspectors such that specific and selected inspection data is available for display (e.g., dates of inspections, inspections completed, among others).

The system can include a device (e.g., a data collection device) used to identify a portion of a structure to trigger or initiate a scheduling of an inspection or an actual inspection. For example, the device may be a portable electronic data collection device. Examples of portable electronic data collection devices include portable cellular devices (e.g., smartphones, other mobile phones, or other portable devices with a wireless cellular telecommunication network connection), digital cameras, webcams, and other portable mobile electronic devices with cameras or other image capturing devices, portable digital assistants, tablets, laptop computers, portable gaming devices, barcode scanners (e.g., dedicated barcode scanners, or devices that perform barcode scanning in addition to other functions), portable electronic location determination devices (e.g., potable Global Positioning System/GPS devices), and the like. In other examples, the device may be a portable data collection device more generally (e.g., a camera), or a data collection device more generally (e.g., a data collection device installed at the location of a structure, such as one or more sensors and related equipment for collecting and/or communication sensor data generated by the sensors). The device can be configured to identify a portion of a structure by capturing (e.g., communicating, sending, and the like) an image of the structure, by scanning a barcode associated with the structure, by reading a Radio Frequency Identification (RFID) tag associated with the structure, by utilizing a GPS device to match a location with a location of a portion of a structure, and/or by utilizing a location determination technique based on cellular triangulation, Near Field Communication (NFC), RFID, or the like.

The device can be used to ascertain whether to perform an inspection. For instance, data collected or identified with the device can be evaluated (e.g., computer-based evaluation, user-based evaluation, or a combination thereof) to determine whether to perform a particular inspection on a portion of the structure. In an embodiment, an image of a portion of a structure can be captured by the device and an evaluation of the image compared to a baseline image (e.g., image of the portion of the structure that does not require an inspection) can be used for comparison. In another embodiment, the data from the device can be communicated to a user to determine whether an inspection should be performed.

The system can include assigning a non-person (e.g., automated, machine-based, video-based, camera-based, remote, among others) inspection based on the identified portion of the structure. In an embodiment, a non-person inspection can be an electronic-based inspection utilizing, for instance, a portion of an image, a video, a video feed, a webcam, a sensor, a live-stream of video, or a combination thereof. For instance, the non-person inspection can be authenticated (e.g., date authentication, structure authentication, location authentication, user authentication, and the like) to reduce fraudulent inspection. In an example, a video or sensor can be activated to capture data that can be used to perform an inspection. In another embodiment, the whole or portion of the structure can be moved or transported to an inspector or an inspection facility or location.

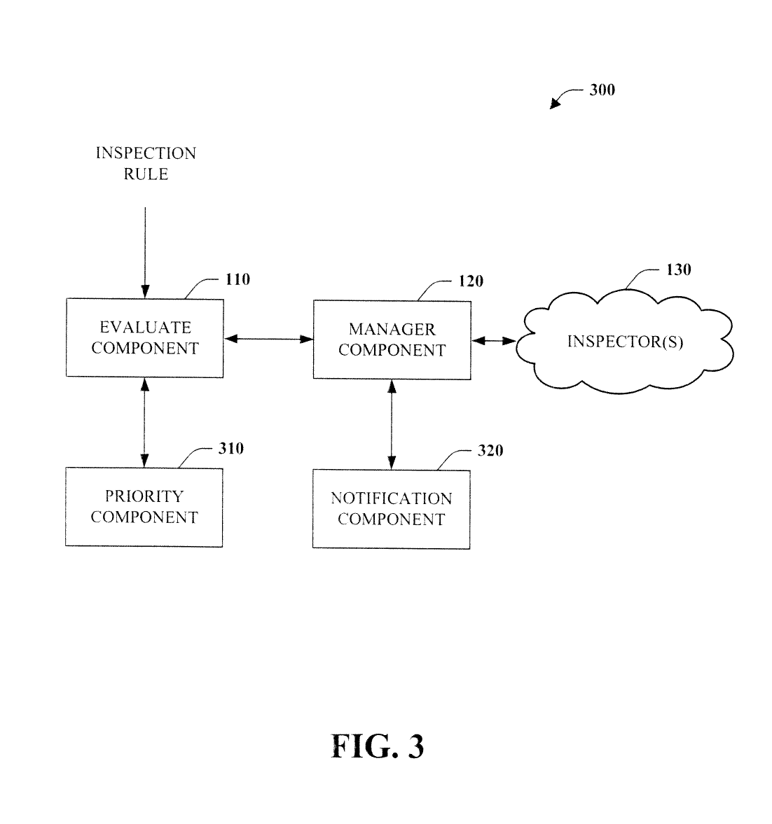

FIG. 3 is an illustration of a system 300 for prioritizing one or more inspections based on an amount of time until an inspection target date. The system 300 includes the evaluate component 110 that is configured to identify at least one of a structure to perform an inspection, an inspection to perform, and a date to perform the inspection based on an inspection rule or set of inspection rules. The manager component 120 is configured to schedule an appointment to perform the inspection with one or more inspectors 130 to indicate a match with an available inspector on the date. In an embodiment, the manager component can evaluate additional factors (discussed above) to select at least one inspector to perform the inspection on the structure.

The system 300 includes a priority component 310 that is configured to sort the scheduling of inspections on a per structure basis or a per inspection basis, for instance. The priority component can identify an importance for each structure and/or each inspection for one or more structures and organize an ordered scheduling based on the importance. For instance, the rank of each structure or inspection can be based on, but not limited to, a type of the inspection, the date for the inspection, a type of structure, the location of the structure, the availability of the structure, an amount of use of the structure, a cost of the inspection (e.g., cost in performing the inspection, cost in downtime for the structure, and the like), a due date to perform the inspection, expected weather and/or environmental conditions, date of last/previous inspection, an amount of time before the due date to perform the inspection, an amount of time lapsed after the due date, and/or a load capacity for the structure, among others. The priority component 310 can be a stand-alone component (as depicted), incorporated into the evaluate component, incorporated into the manage component, or a combination thereof.

In an embodiment, the manager component is configured to record and/or receive data related to the one or more inspectors that performed a particular inspection on a portion of a structure. For instance, a ranking or grade for each inspector and/or individuals aggregated in an organizational structure (e.g., a union, a committee, a board, an elected group, an appointed group of individuals, and the like) can be ascertained based on factors such as, but not limited to, timeliness, frequency of cancellation for a scheduled date, availability, cost, and the like.

The priority component can employ a technique to illustrate a prioritization or importance for a specific structure or inspection on a structure. By way of example and not limitation, the technique can be a color (e.g., red color is high priority, etc.), a text emphasis (e.g., bold, italicize, underline, font size, type of font, among others), and/or a number ranking (e.g., numbered first is important, etc.), among others. For instance, an inspection of high importance can be colored in red and bold in order to illustrate the importance of scheduling or scheduled inspection.

The system may further include a notification component 320 that is configured to communicate a notification related to at least one of inspection data, an inspection result, a scheduled inspection, a structure, a reminder for an inspection, escalation of late inspection notification, a reminder to schedule an inspection, and/or an invoice for an inspection, among others. The notification component can communicate a notification to a company, an entity, a user, a group of users, an employee, a group of employees, a third-party inspector, and/or a local inspector, among others. In an embodiment, the notification can be an e-mail, a text message, a letter, a voice message, an automated message, a calendar notification, an electronic-based message, and/or a non-electronic based portion of text, among others. The notification component 320 can be a stand-alone component (as depicted), incorporated into the evaluate component, incorporated into the manage component, or a combination thereof.

In an embodiment, the priority component can be utilized with the notification component such that the notification can be communicated to an entity corresponding to the importance or priority of the notification or content of the notification. For instance, a high priority ranked inspection can be scheduled and a reminder for such inspection can be communicated to a high priority entity (e.g., user, manager, company, inspector, supervisor, among others).

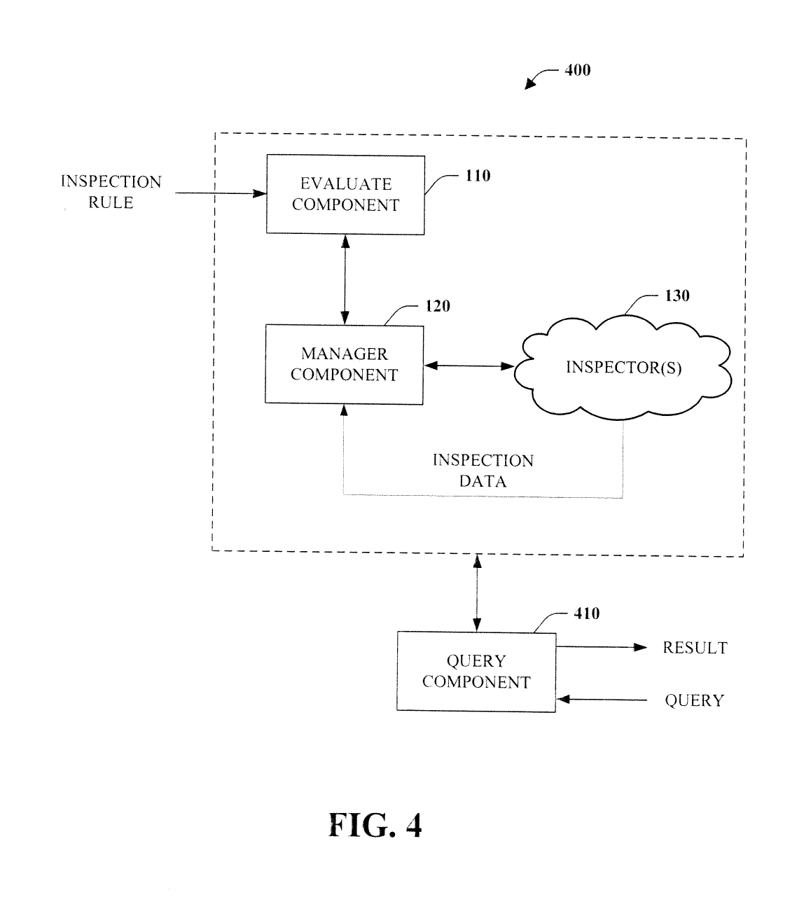

FIG. 4 is an illustration of a system 400 for querying inspection data to provide results related to one or more structures. The system can include a query component 410 that receives a query and generates and/or displays a result to the query. For instance, the query can be received from one or more users and can be related to at least one of a structure, an inspection on a structure, a scheduled inspection, a completed inspection, an inspector, an inspection history for a structure, a compliance list for one or more inspections, a to-do list for inspection(s) for one or more structures, among others. The query component 410 can be a stand-alone component (as depicted), incorporated into the evaluate component, incorporated into the manage component, incorporated into the data store, or a combination thereof.

For instance, a user or group of users can query the inspections that are to be performed on a structure during a specific time frame. In another example, a query can request the number of inspections to be performed on a selected group of structures. In another example, a query can request a cost for inspections on a particular structure. For instance, a query can relate to a cost of inspections made within the past six months. In another example, a query can relate to a cost of inspections scheduled for the next two weeks. In another example, a query can generate a compliance record of inspections for one or more structures. In another example, a query can relate to a review or performance record of one or more inspectors.

The aforementioned systems, components, (e.g., evaluate component, manager component, priority component, notification component, among others), and the like have been described with respect to interaction between several components and/or elements. Such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

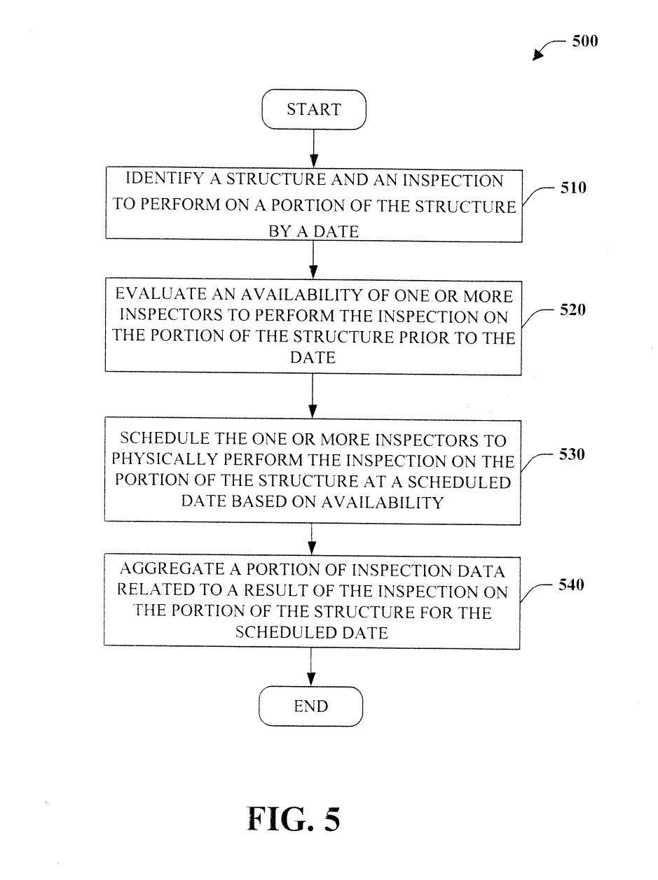

In view of the exemplary devices and elements described supra, methodologies that may be implemented in accordance with the disclosed subject matter are described with reference to the flow chart of FIG. 5. The methodologies are shown and described as a series of blocks/steps, but the claimed subject matter is not limited by the order of the blocks/steps, as some blocks/steps may occur in different orders and/or concurrently with other blocks/steps from what is depicted and described herein. Moreover, not all illustrated blocks/steps may be required to implement the methods described hereinafter. The methodologies can be implemented by a component or a portion of a component that includes at least a processor, a memory, and an instruction stored on the memory for the processor to execute

FIG. 5 illustrates a flow chart of a method 500 for scheduling an appointment for an inspection on a structure based on a due date to perform the inspection and maintaining inspection data related to a result of the inspection. At reference numeral 510, a structure and an inspection to perform on at least a portion of the structure by a date can be identified. At reference numeral 520, an availability of one or more inspectors to perform the inspection on the portion of the structure prior to the date can be evaluated. In an embodiment, a qualification of the one or more inspectors can be evaluated. At reference numeral 530, the one or more inspectors can be scheduled to physically perform the inspection on the portion of the structure at a scheduled date based on availability. In an embodiment, the scheduling to perform the inspection can be based on availability and/or the qualification evaluated. (“Physically” perform means a human inspector being at the structure for carrying out the inspection on the structure.) At reference numeral 540, a portion of inspection data related to a result of the inspection on the portion of the structure for the scheduled date can be aggregated.

The method further includes evaluating a cost of one or more inspectors to perform the inspection on the portion of the structure prior to the date and scheduling the one or more inspectors to physically perform the inspection on the portion of the structure at a scheduled date based on the cost. In an embodiment, the method can include evaluating at least one of a risk, potential fine avoidance for late tests, response to an accident or audit, use of structure for high-profile event, among others for the structure to determine a scheduling of an inspection. The method further includes the inspection is at least one of user-defined, defined by an owner of the structure, or defined by a manufacturer of the portion of the structure. The method further includes the inspection is based on at least one of a law, a government entity, an agency, the FRA, OSHA, or a committee. The method further includes evaluating a type of the structure (e.g., bridge, building, crane, type of bridge, type of building, material (e.g., brick, wood, steel, etc.) of the structure, commercial structure or residential structure, among others) to ascertain the date to perform the inspection. The method further includes identifying at least one of a frequency or a duration of time for the inspection of the portion of the structure. The method further includes scheduling the one or more inspectors to physically perform the inspection on the portion of the structure at a scheduled date based on at least one of the frequency or the duration of time.

The method further includes prioritizing the scheduling of inspections for structures based on at least one of a type of the inspection or the date for the inspection. The method includes communicating a notification related to at least one of the inspection, the scheduled data, or the one or more inspectors. The method can identify an additional inspection to perform on the portion of the structure based on the inspection at the scheduled date. The method includes ranking the one or more inspectors and/or individuals aggregated in an organizational structure, based on at least one of a timeliness, a frequency of cancellation for a scheduled date, an availability, or a cost. The method further includes querying the portion of inspection data to identify a compliance list for one or more structures and one or more respective inspections. The method can further include generating an electronic inspection history file that includes an identification of a structure, one or more inspections, one or more dates of the inspections, and one or more results for the inspections. The method further includes providing read access to the electronic inspection history file to the one or more inspectors.

The method can include utilizing a device (e.g., a portable electronic data collection device) as described above to identify a portion of a structure. The device can identify a portion of a structure by capturing (e.g., communicating, sending, and the like) an image of the structure, by scanning a barcode associated with the structure, by reading an RFID tag associated with the structure, by utilizing a GPS device to match a location with a location of a portion of a structure, and/or utilizing a location determination technique based on cellular triangulation, NFC, RFID, among others.

The method can include utilizing the device to ascertain whether to perform an inspection. For instance, data collected or identified with the device can be evaluated (e.g., computer-based evaluation, user-based evaluation, combination thereof) to determine whether to perform a particular inspection on a portion of the structure. In an embodiment, an image of a portion of a structure can be captured by a device and an evaluation of the image compared to a baseline image (e.g., image of the portion of the structure that does not require an inspection) can be used for comparison. In another embodiment, the data from the device can be communicated to a user to determine whether an inspection should be performed.

The method can further include assigning a non-person inspection based on the identified portion of the structure. In an embodiment, a non-person inspection can be an electronic-based inspection utilizing, for instance, a portion of an image, a video, a video feed, a webcam, a sensor, a live-stream of video, or a combination thereof. For instance, the non-person inspection can be authenticated (e.g., date authentication, structure authentication, location authentication, user authentication, and the like) to reduce fraudulent inspection. In an example, a video or sensor can be activated to capture data that can be used to perform an inspection. In another embodiment, the portion of the structure can be moved or transported to an inspector or an inspection facility or location.

The method can further include evaluating a portion of data related to an inspector or team of inspectors and assigning or scheduling an inspector or team of inspectors for an inspection based on such evaluation. The portion of data related to the inspector(s) can be, but is not limited to, inspector(s) criteria, inspector(s) skill requirement, inspector(s) skill set, inspector tool availability, inspector(s) tool load out, a criticality of the portion of the structure being viewed, mode of transportation of an inspector(s), inspector(s) location, equipment experience, equipment required for inspection, a confined space entry safety, activity for inspection (e.g., pole climbing, underwater diving, key required for entry to locked cabinet, entry code, entry code generated for particular inspector or inspection, inspection of the portion of the device required to be operating, co-scheduling with an operator, and the like.

The method can further allow a device to push structure history to the scheduled inspector or team of inspectors and supplement with additional information such as, but not limited to, weather, trends from like structures needing repairs, local to the inspection site traffic patterns, specification data for the inspection (e.g., images, video, and the like on what the portion of the structure should be, inspection instructions step-by-step (or a video “how to”), notes from previous inspections, and the like). In any of the embodiments set forth herein, the methods may be carried out at least partially automatically, by an electronic system. For example, a method may comprise automatically identifying, with a controller or other electronic system, a structure and an inspection to perform on at least a portion of the structure that is associated with an inspection date. The method further comprises automatically evaluating, with the electronic system, (i) an availability of one or more inspectors to perform the inspection on the portion of the structure no later than the inspection date and (ii) a qualification of the one or more inspectors. The method further comprises automatically scheduling, with the electronic system, the one or more inspectors to perform the inspection on the portion of the structure at a scheduled date based on at least one of the availability or the qualification, and automatically aggregating a portion of inspection data related to a result of the inspection on the portion of the structure.

In an embodiment, a system is provided that includes means for identifying a structure and an inspection to perform on at least a portion of the structure by an inspection date (e.g., evaluate component); means for evaluating an availability of one or more inspectors to perform the inspection on the portion of the structure no later than the inspection date (e.g., manager component); means for scheduling the one or more inspectors to perform the inspection on the portion of the structure at a scheduled date (e.g., manager component); and means for aggregating a portion of inspection data related to a result of the inspection on the portion of the structure (e.g., manager component). The system can further include means for evaluating a cost of the one or more inspectors to perform the inspection on the portion of the structure no later than the inspection date (e.g., manager component); wherein the means for scheduling is configured for scheduling the one or more inspectors to perform the inspection on the portion of the structure at the scheduled date based on the cost.

In an embodiment, a system comprises an evaluate component configured to automatically identify an inspection to perform on at least a portion of a structure that is associated with an inspection date. The system further comprises a manager component operably coupled with the evaluate component and configured to automatically schedule one or more inspectors to perform the inspection on the portion of the structure at a scheduled date based at least on an availability of the one or more inspectors and a qualification of the one or more inspectors, the scheduled date being no later than the inspection date, wherein the manager component is configured to receive inspection data related to a result of the inspection on the portion of the structure.

In any of the systems and methods described herein, some or all of the various functions and steps of the system and methods, respectively, can be carried out automatically, meaning by an electronic device configured to perform the functions or steps (as applicable) without the need for human action. This includes the possibility of automatic action based on human input, and also systems and methods where some steps are performed automatically and others performed by human operators.

In any of the systems described herein, a component of the system may be further configured to automatically control (which includes automatically generating signals for controlling) a structure based on inspection data related to a result of an inspection on at least a portion of the structure (that is, data related to a result of an inspection on the structure generally or a portion of the structure). Examples of automatic control may include preventing operation of the structure (e.g., preventing a crane from being operated, or a drawbridge from being raised), controlling the structure from one mode of operation to another (e.g., controlling movement of the structure from a first position to a different, second position, such as lowering a crane boom to a maintenance position), controlling the structure or related infrastructure to prevent or discourage access to the structure (e.g., preventing vehicles from crossing a bridge, activating warning signs or notices associated with the structure, etc.), automatically generating signals that result in authorities or other designated personnel taking designated action in relation to the structure (e.g., preventing access to the structure), automatically delaying scheduled use of or access to the structure (e.g., by automatically modifying a calendar, work order, etc. associated with the structure) until after maintenance and/or a subsequent inspection, or the like. (Similarly, any of the methods described herein may include a step of automatically controlling a structure based on inspection data related to a result of an inspection on at least a portion of the structure.)

In any of the systems described herein, a component of the system may be further configured to automatically schedule maintenance operations on a structure based on inspection data related to a result of an inspection on at least a portion of the structure. The component of the system may be configured to automatically schedule the maintenance operations, in terms of priority and/or expediency, as a function of to what extent the inspection data deviates from designated maintenance/condition criteria for safe access/use of the structure. (Similarly, any of the methods described herein may include a step of automatically scheduling maintenance operations on a structure based on inspection data related to a result of an inspection on at least a portion of the structure.)

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function, and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using a devices or systems and performing incorporated methods. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A method, comprising:
identifying a structure and an inspection to perform on at least a portion of the structure that is associated with an inspection date;
evaluating at least one of an availability of one or more inspectors to perform the inspection on the portion of the structure no later than the inspection date or a qualification of the one or more inspectors, wherein the one or more inspectors are scheduled to perform the inspection on the portion of the structure at a scheduled date based on at least one of the availability or the qualification; and
aggregating inspection data related to a result of the inspection on the portion of the structure.

2. The method of claim 1, further comprising:
evaluating a cost of the one or more inspectors to perform the inspection on the portion of the structure no later than the inspection date; and
scheduling the one or more inspectors to physically perform the inspection on the portion of the structure on the scheduled date based at least in part on the cost.

3. The method of claim 1, wherein:
the structure is identified based on an output of a portable data collection device; and
the method further comprises initiating the scheduling of the one or more inspectors to perform the inspection based on the output of the device.

4. The method of claim 3, further comprising ascertaining whether to perform the inspection based on data captured by the device.

5. The method of claim 1, further comprising:
evaluating a type of the structure to ascertain the inspection date to perform the inspection; and
scheduling the one or more inspectors to physically perform the inspection on the portion of the structure based on an availability of the structure.

6. The method of claim 1, further comprising:
identifying at least one of a frequency or a duration of time for the inspection of the portion of the structure; and
scheduling the one or more inspectors to physically perform the inspection on the portion of the structure at the scheduled date based on at least one of the frequency or the duration of time.

7. The method of claim 1, further comprising prioritizing scheduling of one or more inspections for one or more structures based on a parameter associated with at least one of: a type of inspection; an inspection location; or an inspection date.

8. The method of claim 1, further comprising communicating a notification related to at least one of the inspection, the scheduled date, or the one or more inspectors.

9. The method of claim 1, wherein the method further comprises, responsive to the inspection at least one of being inconclusive or indicating a problem, identifying an additional inspection to perform on the portion of the structure no later than the inspection date.

10. The method of claim 1, further comprising ranking at least one of the following:
the one or more inspectors based on at least one of a timeliness of the one or more inspectors, a frequency of cancellation of the one or more inspectors, an availability of the one or more inspectors, or a cost of the one or more inspectors; or
one or more individuals aggregated in an organizational structure based on at least one of a timeliness of the one or more individuals, a frequency of cancellation of the one or more individuals, an availability of the one or more individuals, or a cost of the one or more individuals.

11. The method of claim 1, further comprising querying the inspection data to identify a compliance list for one or more structures and one or more respective inspections.

12. The method of claim 1, further comprising generating an electronic inspection history file that includes an identification of the structure, one or more inspections, a date of the one or more inspections, and one or more results for the one or more inspections.

13. The method of claim 1, further comprising:
evaluating a portion of data related to an inspector of the one or more inspectors; and
assigning the inspector to the inspection based on the evaluation of the portion of data.

14. A system comprising:
a first component configured to identify an inspection to perform on at least a portion of a structure based on at least one of a frequency for the inspection, a duration of time for the inspection, or a type of the structure; and
a second component configured to identify one or more inspectors to perform the inspection on the portion of the structure, wherein the second component is further configured to schedule the inspection with the one or more identified inspectors.

15. The system of claim 14, further comprising a third component configured to collect inspection data related to a result of the scheduled inspection for the portion of the structure with the one or more identified inspectors.

16. The system of claim 14, further comprising a fourth component configured to schedule the inspection before another inspection based on an amount of time before at least one of a deadline related to the frequency or a deadline related to the duration of time, wherein the fourth component is further configured to query and retrieve a result for the query, wherein the query relates to at least one of the scheduled inspection, the one or more inspectors, the structure, the inspection, or a portion of inspection data related to a result of the inspection.

17. A system comprising:
means for identifying a structure and an inspection to perform on at least a portion of the structure by an inspection date;
means for evaluating an availability of one or more inspectors to perform the inspection on the portion of the structure no later than the inspection date;
means for scheduling the one or more inspectors to perform the inspection on the portion of the structure at a scheduled date; and
means for aggregating inspection data related to a result of the inspection on the portion of the structure.

18. The system of claim 17, further comprising:
means for evaluating a cost of the one or more inspectors to perform the inspection on the portion of the structure no later than the inspection date;
wherein the means for scheduling is configured for scheduling the one or more inspectors to perform the inspection on the portion of the structure at the scheduled date based on the cost.

19. A system comprising:
an evaluate component configured to automatically identify an inspection to perform on at least a portion of a structure that is associated with an inspection date; and
a manager component operably coupled with the evaluate component and configured to automatically schedule one or more inspectors to perform the inspection on the portion of the structure at a scheduled date based at least on an availability of the one or more inspectors and a qualification of the one or more inspectors, the scheduled date being no later than the inspection date, wherein the manager component is configured to receive inspection data related to a result of the inspection on the portion of the structure.

20. The system of claim 19, wherein at least one of the evaluate component or the manager component is configured to automatically control the structure based on the inspection data.
